(19) United States
(12) Patent Application Publication
(10) Pub. No.: US 2024/0200782 A1
(43) Pub. Date: Jun. 20, 2024

(54) Portable Combination Cooker

(71) Applicant: RS PRODUCTS, LLC, Draper, UT (US)

(72) Inventors: Kevin L. SMITH, Draper, UT (US); Paul G. RAYMOND, Saratoga Springs, UT (US); Doug HORTON, Highland, UT (US)

(21) Appl. No.: 18/021,481

(22) PCT Filed: Oct. 28, 2020
(86) PCT No.: PCT/US2020/057801

§ 371 Date: Jul. 27, 2023

(51) Int. Cl. F24C 1/16; A47J 37/06; A47J 37/07; F24C 15/10; F24C 15/16

(52) U.S. Cl. CPC F24C 1/16; A47J 37/0664; A47J 37/0772; A47J 37/0786; F24C 15/10; F24C 15/16; A47J 2037/0777

(57) ABSTRACT

In one embodiment, a portable combination cooking apparatus that has a collapsible unit with at least four walls, a top, and a bottom that are all mechanically coupled together. The top includes a groove for draining undesirable elements such as grease from a cooking surface. Other embodiments are also disclosed.

### BACKGROUND OF THE INVENTION

### 1. Technical Field

The present invention relates generally to cooking devices, and more specifically, to a portable combination food cooker and self-contained, portable firepit device.

### 2. Description of the Related Art

Multipurpose food cookers are known in the art. For example, U.S. Pat. No. 9,980,606 B2 issued to Marra, discloses concepts related to a multipurpose cooking appliance such as a cooking appliance that offers multiple cooking surfaces. For example, a user can choose to bake, grill, or smoke food—all with the same appliance.

In addition, commercial appliances such as an all-in-one breakfast maker are known where sausage, eggs, toast, and coffee are all prepared or warmed with a single portable appliance.

The following disclosure relates to improvements in the art; non-obvious improvements, as demonstrated by the failure of those of ordinary skill in the art to implement such improvements after having available the benefit of these earlier cooking disclosures for many years.

### SUMMARY

It has been discovered that at least the aforementioned challenges are resolved by an apparatus as disclosed herein. Upon viewing the present disclosure, one of ordinary skill in the art will appreciate that variations of principles according to the present invention could be contemplated.

For example, in one inventive embodiment, a portable combination cooker apparatus is disclosed where a collapsible unit has at least four walls, a top, and a bottom that are all mechanically coupled together.

The top is constructed of a flat cooking surface that is mechanically coupled to at least one of the at least four walls such that it may be folded adjacent to the at least four walls when the walls are collapsed.

The bottom is constructed as a flat surface that counter recesses inside the at least four walls to add support to the cooker apparatus when operating. The bottom also has at least one support structure mechanically coupled thereto. The at least one support structure is mechanically coupled to the bottom such that the cooker apparatus is stable when freely standing.

Also included is a handle that is mechanically coupled to the collapsible unit such that a user can lift the cooker apparatus without being burned while the cooker apparatus is in operation.

In certain embodiments, the top of the portable combination cooker apparatus comprises a flat cooking surface having a hinge on one side for mechanically coupling to the collapsible unit. The portable combination cooker apparatus may also include a flat surface on the bottom that is counter-recessed to add support to the collapsible unit when standing. The bottom may also include retractable legs and a hinge for mechanically coupling to the collapsible unit.

In other embodiments, the portable combination cooker apparatus includes a drip-cup that is removably coupled to the collapsible unit such that debris from the top may be collected in one place for simple disposal. Also, it is to be understood by those of ordinary skill in the art and viewing the present disclosure that food may simply be warmed rather than cooked.

Still further, in some embodiments, one of the at least four walls of the collapsible unit of the portable combination cooker apparatus includes a removable sheet wherein internal arrangement of the portable combination cooker apparatus can be exposed for viewing from the exterior.

In certain embodiments, two of the at least four walls of the collapsible unit of the portable combination cooker apparatus include a hinge for folding when the collapsible unit is collapsed, at least one adjustable rack is disposed internally to the portable combination cooker apparatus. A top having at least one tab for lifting the top from the at least four walls of the collapsible unit, and the handle being disposed such that a grip portion is not touching the at least four walls of the collapsible unit.

In a second example of a portable combination cooker apparatus of the present disclosure, a collapsible unit with at least four walls, a top, and a bottom are all mechanically coupled together. The top is constructed of a flat cooking surface that has at least one tab for tilting the flat cooking surface. The flat cooking surface is mechanically coupled to at least one of the at least four walls of the portable cooking apparatus such that it may be folded adjacent to the at least four walls when the walls are collapsed.

The bottom is constructed as a flat surface that counter recesses inside the at least four walls to add support to the cooker apparatus when operating. The bottom also has at least one support structure mechanically coupled to it, and the at least one support structure is mechanically coupled to the bottom such that the cooker apparatus is stable when freely standing.

Finally, a handle is mechanically coupled to the collapsible unit such that a user can lift the cooker apparatus while the cooker apparatus is in operation.

In certain embodiments of the second example, the top of the portable combination cooker apparatus is a flat cooking surface having a hinge on one side for mechanically coupling to the collapsible unit. The bottom is a flat surface that is counter-recessed to add support to the collapsible unit when standing. The bottom includes retractable legs and a hinge for mechanically coupling to the collapsible unit. Also included in the second example of the portable combination cooker apparatus is a drip-cup that is removably coupled to the collapsible unit such that debris from the top may be collected in one place for simple disposal.

In one embodiment of the second example, one of the at least four walls of the collapsible unit of the portable combination cooker apparatus includes a removable sheet wherein internal arrangements of the portable combination cooker apparatus can be exposed. Also, two of the at least four walls of the collapsible unit include a hinge for folding when the collapsible unit is collapsed, and at least one adjustable rack is disposed internally to the portable combination cooker apparatus.

In a final example of a portable combination cooker apparatus built according to principles of the present invention, there is disclosed a collapsible unit having at least four walls, a top, and a bottom that are all mechanically coupled together.

The top is constructed of a flat cooking surface. The flat cooking surface has at least one tab for tilting the flat cooking surface, and the flat cooking surface is mechanically coupled to at least one of the at least four walls such that it may be folded adjacent to the at least four walls when the walls are collapsed.

The bottom is constructed as a flat surface that counter recesses inside the at least four walls to add support to the cooker apparatus when operating. The bottom has at least one support structure mechanically coupled to it, and the at least one support structure is mechanically coupled to the bottom such that the cooker apparatus is stable when freely standing.

Also included in the third example are a handle mechanically coupled to the collapsible unit such that a can lift the cooker apparatus while the cooker user apparatus is in operation, and a drip-cup that is removably coupled to the collapsible unit such that debris from the top may be collected in one place for simple disposal.

In addition, the portable combination cooker apparatus of example three may have the flat cooking surface of the top including a groove that is aligned with the drip-cup for channeling fluid debris from the flat cooking surface of the top into the drip-cup. Also, the portable combination cooker apparatus of example three may include the handle being disposed apart from the portable combination cooker apparatus where a user may grip the handle without risking being burned.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings.

FIG. 1 is a perspective view of a portable combination cooker apparatus constructed according to principles of the present invention;

FIG. 2 is another perspective view of the portable combination cooker apparatus of FIG. 1, the portable combination cooker apparatus illustrated having an open side to show internal arrangements of one embodiment;

FIG. 3 illustrates an inverted perspective view of an oven floor of the portable combination cooker apparatus of FIG. 1;

FIG. 4 illustrates a perspective view of a detachable griddle-lid of the portable combination cooker apparatus of FIG. 1; and

FIG. 5 illustrates a perspective view of a drip cup of the portable combination cooker apparatus of FIG. 1.

### DETAILED DESCRIPTION

The following provides a detailed description of examples of the present invention and should not be taken to be limiting of the invention itself. Rather, any number of variations may fall within the scope of the invention, which is defined in the claims following this detailed description.

Reference will now be made in detail to embodiments of the invention illustrated in accompanying drawings. Whenever possible, the same or similar reference numerals are used in the drawings and the description to refer to the same or like parts, acts, or steps. The drawings are in simplified form.

Those of ordinary skill in the art will appreciate that in the development of any such actual implementation, as in any engineering or design project, numerous implementation-specific decisions must be made to achieve the developer's specific goals, such as compliance with system-related, metallurgical-related constraints, which may vary from one implementation to another. Such would be a routine undertaking of design, fabrication, and manufacture for those of ordinary skill in the art and having the benefit of the present disclosure.

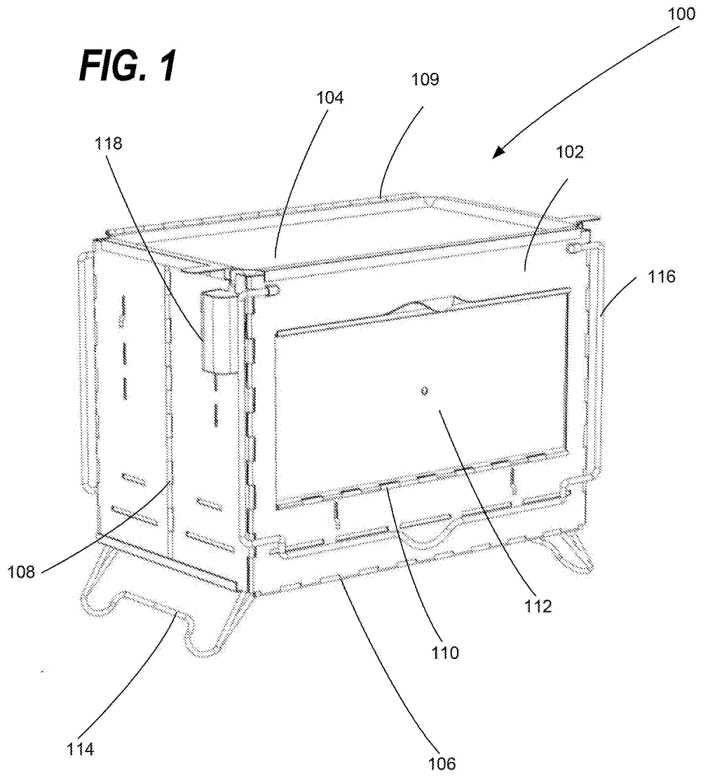

In the drawings, FIG. 1 is a perspective view of a portable combination cooker apparatus 100 constructed according to principles of the present invention. Portable combination cooker apparatus 100 is a collapsible unit with a housing that includes four walls 102, a top 104, and a bottom 106.

Although only a single wall of the housing is labeled, those of ordinary skill in the art will appreciate that four walls 102 make up the first part of the collapsible unit or housing.

In addition to four walls 102, portable combination cooker apparatus 100 also includes a top 104 and a bottom 106. Top 104 serves multiple purposes of which one is being a griddle for cooking food such as bacon, eggs, or pancakes. One purpose of bottom 106 is to add stability to portable combination cooker apparatus when in operation. This stability is added by forming a recessed floor of portable combination cooker apparatus.

Four walls 102 include a hinge 108 in the middle of two of the four side walls. Hinge 108 allows four walls 102 to work as a collapsible housing when desired. Of note, top 104 also includes a hinge 109 that may keep top 102 attached to four walls 102 when desired.

Another hinge 110 is mechanically coupled to one of four walls 102 which allows a side 112 of four walls 102 to open like an oven door. When side 112 is opened, the inside of four walls 102 is exposed and access is granted to the inner workings of four walls 102 when portable combination cooker apparatus 100 is standing.

Also shown in FIG. 1 are legs 114 which serve as a support structure for portable combination cooker apparatus 100. Legs 114 allow portable combination cooker apparatus to stand freely on most surfaces. If portable combination cooker apparatus needs to be moved, a handle 116 is available to pick up and move portable combination cooker apparatus. Handle 116 is located on the exterior of portable combination cooker apparatus for at least the reason of protecting a person from being burned from touching handle 116. Thus, portable combination cooker apparatus is moveable to alternate locations even when in operation as a warm portable cooker.

Also illustrated in FIG. 1 is a drip cup 118. Drip cup 118 is positioned on portable combination cooker 100 to catch grease or other cooking waste that may run or slide off of top 104 when used as a griddle.

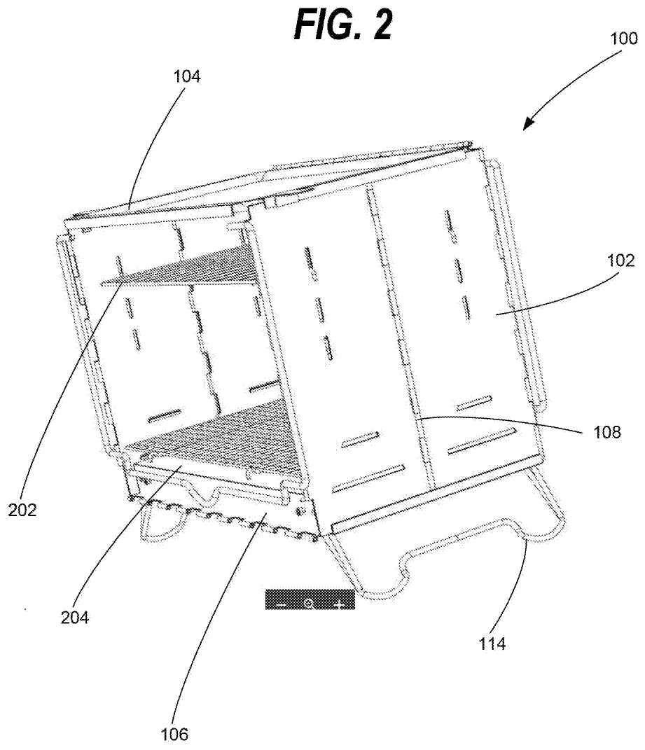

In a perspective view of a part of portable combination cooker apparatus 100 of FIG. 1, FIG. 2 illustrates portable combination cooker apparatus 100 having an open side 112 to show internal arrangements of one embodiment. For reference purposes, four walls 102, top 104, bottom 106, legs 118, and hinge 110 are labeled.

Also shown is an upper rack 202 and a lower rack 204. Upper rack 202 may be placed near top 104, near bottom 106, or anywhere in between depending on cooking and heating plans. Lower rack 204 is placed according to fuel source.

For example, the fuel source could be charcoal briquettes. Charcoal briquettes need different space than wood chips. Sufficient amounts of oxygen is typically required to reach the fuel source for combustion purposes. If another source of cooking heat were used, upper rack 202 may need to be moved closer to the heat source, or otherwise. Likewise, lower rack 204 may need adjusting to accommodate another heat source such as propane, solar or even some other heating source.

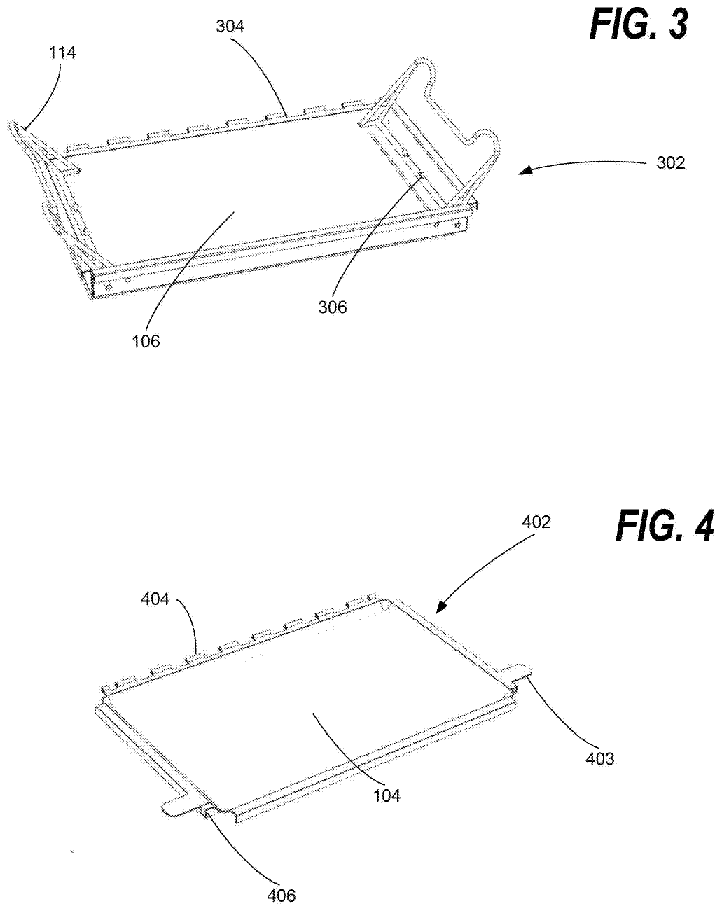

FIG. 3 illustrates an inverted perspective view of an oven floor 302 of portable combination cooker apparatus 100 of FIG. 1. For purposes of reference, bottom 106 and legs 114 are also labeled.

Floor 302 operates as a recessed oven floor in order to enhance stability in four walls 102 shown in FIG. 1. This stability is enhanced by a floor hinge 304 of recessed oven floor that provides floor 302 a means for mechanically coupling to the housing that is constructed with four walls 102. Floor 302 also includes a retractable feet hinge 306 that serves to allow legs 114 to add further support and strength to a collapsed portable combination cooker apparatus.

FIG. 4 illustrates a perspective view of a griddle-lid 402 of the portable combination cooker apparatus 100 of FIG. 1. Top 104 is labeled for purposes of reference.

As illustrated, griddle-lid 402 includes a tab 403 for lifting open griddle-lid 402 as it opens with a griddle-lid hinge 404. Also illustrated in FIG. 4 is a griddle spout 406 that provides a pathway for debris such as grease to exit griddle-lid 402, for example, bacon grease.

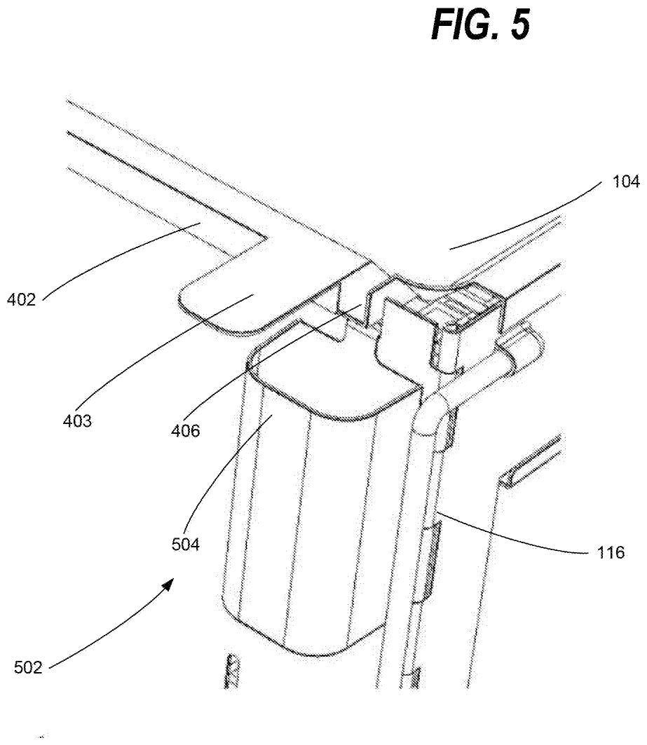

FIG. 5 illustrates a perspective view of a drip cup 502 of the portable combination cooker apparatus 100 of FIG. 1. For purposes of reference, also labeled are top 104, handle 116, griddle-lid 402, tab 403, and griddle spout 406

As fluid debris, for example bacon grease, flows from griddle-lid 402 and through griddle spout 406, the debris drips into drip cup 502 where it collects for simple disposal when cooking has completed for a particular meal.

Drip cup 502 has durable walls 504 for holding indefinitely whatever debris happens to be removed from griddle-lid 402 through flowing or scraping or whatever means are used to keep griddle-lid 402 clean.

Upon viewing the present disclosure, those of ordinary skill in the art will appreciate that other equivalent materials and steps could be substituted to realize the presently disclosed invention.

Although various disclosure embodiments have been described in the foregoing detailed description and illustrated in the accompanying drawings, it will be understood that the presently disclosed invention is not limited to the embodiments disclosed, but indeed may assume numerous arrangements, re-arrangements, modifications, and substitutions of elements or steps without departing from the spirit and intended scope of the invention herein set forth. The appended claims are to encompass within their scope all such changes and modifications as are within the true spirit and scope of this invention.

Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present.

For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

1. A multifunctional oven apparatus comprising:
a collapsible unit having at least four walls, a top, and a bottom that are all mechanically coupled together;
said top being constructed of a flat cooking surface that is mechanically coupled to at least one of the at least four walls such that it may be folded adjacent to the at least four walls when the walls are collapsed;
said bottom being constructed as a flat surface that counter recesses inside the at least four walls to add support to the multifunctional oven apparatus when operating;
said bottom having at least one support structure mechanically coupled, the at least one support structure being mechanically coupled to the bottom such that the multifunctional oven apparatus is stable when freely standing;
a drip-cup is removably coupled to the collapsible unit such that debris from the top may be collected in one place for simple disposal; and
a handle mechanically coupled to the collapsible unit such that a user can lift the cooker apparatus while the multifunctional oven apparatus is in operation.

2. The multifunctional oven apparatus of claim 1 wherein the top comprises a flat cooking surface having a hinge on one side for mechanically coupling to the collapsible unit.

3. The multifunctional oven apparatus of claim 1 wherein the bottom comprises a flat surface that is counter-recessed to add support to the collapsible unit when standing, retractable legs, and a hinge for mechanically coupling to the collapsible unit.

4. (canceled)

5. The multifunctional oven apparatus of claim 1 wherein one of the at least four walls of the collapsible unit comprises a removable sheet wherein internal arrangement of the multifunctional oven apparatus can be exposed.

6. The multifunctional oven apparatus of claim 1 wherein two of the at least four walls of the collapsible unit include a hinge for folding when the collapsible unit is collapsed.

7. The multifunctional oven apparatus of claim 1 including at least one adjustable rack disposed internally to the multifunctional oven apparatus.

8. The multifunctional oven apparatus of claim 1 wherein the top includes at least one tab for lifting the top from the at least four walls of the collapsible unit.

9. The multifunctional oven apparatus of claim 1 wherein the handle is disposed such that a grip portion is not touching the at least four walls of the collapsible unit.

10. A multifunctional oven apparatus comprising:
a collapsible unit having at least four walls, a top, and a bottom that are all mechanically coupled together;
said top being constructed of a flat cooking surface, the flat cooking surface having at least one tab for tilting the flat cooking surface, the flat cooking surface being mechanically coupled to at least one of the at least four walls such that it may be folded adjacent to the at least four walls when the walls are collapsed;
said bottom being constructed as a flat surface that counter recesses inside the at least four walls to add support to the multifunctional oven apparatus when operating;
said bottom having at least one support structure mechanically coupled, the at least one support structure being mechanically coupled to the bottom such that the multifunctional oven apparatus is stable when freely standing;
a drip-cup is removably coupled to the collapsible unit such that debris from the top may be collected in one place for simple disposal; and
a handle mechanically coupled to the collapsible unit such that a user can lift the multifunctional oven apparatus while the cooker apparatus is in operation.

11. The multifunctional oven apparatus of claim 10 wherein the top comprises a flat cooking surface having a hinge on one side for mechanically coupling to the collapsible unit.

12. The multifunctional oven apparatus of claim 10 wherein the bottom comprises a flat surface that is counter-recessed to add support to the collapsible unit when standing, retractable legs, and a hinge for mechanically coupling to the collapsible unit.

13. (canceled)

14. The multifunctional oven apparatus of claim 10 wherein one of the at least four walls of the collapsible unit comprises a removable sheet wherein internal arrangement of the multifunctional oven apparatus can be exposed.

15. The multifunctional oven apparatus of claim 10 wherein two of the at least four walls of the collapsible unit include a hinge for folding when the collapsible unit is collapsed.

16. The multifunctional oven apparatus of claim 10 including at least one adjustable rack disposed internally to the multifunctional oven apparatus.

17. A multifunctional oven apparatus comprising:
a collapsible unit having at least four walls, a top, and a bottom that are all me chanically coupled together;
said top being constructed of a flat cooking surface, the flat cooking surface having at least one tab for tilting the flat cooking surface, the flat cooking surface being mechanically coupled to at least one of the at least four walls such that it may be folded adjacent to the at least four walls when the walls are collapsed;
said bottom being constructed as a flat surface that counter recesses inside the at least four walls to add support to the multifunctional oven apparatus when operating;
said bottom having at least one support structure mechanically coupled, the at least one support structure being mechanically coupled to the bottom such that the multifunctional oven apparatus is stable when freely standing;
a handle mechanically coupled to the collapsible unit such that a user can lift the multifunctional oven apparatus while the multifunctional oven apparatus is in operation; and
a tray being removably coupled to the collapsible unit such that debris from the top may be collected in one place for simple disposal.

18. The multifunctional oven apparatus of claim 17 wherein the flat cooking surface of the top further comprises a groove being aligned with a drip-cup for channeling fluid debris from the flat cooking surface of the top into the drip-cup.

19. The multifunctional oven apparatus of claim 17 wherein the handle is disposed apart from the multifunctional oven apparatus where a user may grip the handle.
